(19) United States
(12) Patent Application Publication
(10) Pub. No.: US 2020/0329012 A1
(43) Pub. Date: Oct. 15, 2020

(54) SYSTEM AND METHOD FOR DEDICATED STORAGE, THROUGH A SECURE INTERNET CONNECTION, IN A REMOTE LOCATION

(71) Applicant: THE ANTI-CLOUD CORPORATION, Reading, PA (US)

(72) Inventors: Jeffrey Robert HOFFMAN, Media, PA (US); Thomas Eugene KUNZ, Shartlesville, PA (US); Lance GRIBBIN, Leesport, PA (US)

(21) Appl. No.: 16/839,934

(22) Filed: Apr. 3, 2020

Related U.S. Application Data
(60) Provisional application No. 62/828,564, filed on Apr. 3, 2019.

(51) Int. Cl. H04L 29/06; G06F 16/21; H04L 29/08

(52) U.S. Cl. CPC H04L 63/0272; H04L 67/1097; G06F 16/21

(57) ABSTRACT

A system and method for providing dedicated storage through a secure internet connection in a remote location are disclosed. The system and method form an “anti-cloud system” by storing an end user's data only in a location over which the end user has both logical and physical control. Data within this system and method are stored on a primary block device and on a secondary block device that is mirrored at the start for redundancy and these drives are under both the logical and physical control of the end user. These specific block devices do not contain data from any other end user and therefore the specific end user is in possession of all copies. Should the specific end user wish to destroy all of his/her data, the destruction of the two block devices will guarantee that no other copies of his/her data are extant.

### CROSS-REFERENCE TO RELATED APPLICATIONS

This non-provisional application claims the benefit under 35 U.S.C. § 119(e) of Application Ser. No. 62/828,564 filed on Apr. 3, 2019 entitled METHOD AND APPARATUS FOR DESIGNATED STORAGE IN A CLOUD COMPUTING ENVIRONMENT and whose entire disclosure is incorporated by reference herein.

### BACKGROUND OF THE INVENTION

Cloud services generally provide data storage with optional encryption. Data is stored in a manner so that it is physically spread across multiple unspecified servers and storage devices. A cloud user is not able to ensure they retain physical control of data. Copies of data may persist despite requests or court orders to destroy those copies of the data. Due to the shared nature of cloud services, in its native format, all copies of the data cannot be physically transferred to the end user without also transferring data owned by other users. Data for all users of a cloud system is co-mingled between storage devices. Even if users were given physical control of those cloud systems, that data is not in a format readily usable on the user's home PC or existing IT infrastructure and it would have to be extracted and reconstructed into a format that would be directly usable. Cloud data, by its nature, is not readily usable outside of the specific cloud in which it was created.

Thus, there remains a need to provide a system and method that addresses these concerns. The present invention addresses those needs.

All references cited herein are incorporated herein by reference in their entireties.

### BRIEF SUMMARY OF THE INVENTION

A first aspect of the invention is a system for providing an end user (implying an end user device such as computer, laptop, etc.) with dedicated storage over a secure internet connection in a remote location. The system comprises: a data assimilation server cluster which uses unique keysets for maintaining data of the end user private, wherein the data assimilation server is in communication with the end user over the secure internet connection via a router; a database in communication with the data assimilation server cluster for storing data used to configure a connection between the end user and the data assimilation server cluster; a primary block device; and a secondary block device, wherein the connection between the end user and the data assimilation server cluster comprises a connection between the end user and the primary block device and the secondary block device and wherein each of the primary block device and the secondary block device provides dedicated access to the end user such that the primary block device and the secondary block device contain no other data other than the data of the end user and the primary block device and the secondary block device are logically and physically controlled by the end user.

A second aspect of the invention is a method for providing an end user (implying an end user device such as computer, laptop, etc.) with dedicated storage over a secure internet connection in a remote location is disclosed. The method comprises: providing a data assimilation server cluster that is in communication over the secure internet connection using a router, wherein the data assimilation server cluster comprises unique keysets for maintaining data of the end user private; connecting a database in communication with the data assimilation server cluster, wherein the database stores data used to configure a connection between the end user and the data assimilation server cluster; and wherein the connection between the end user and the data assimilation server cluster comprises forming a connection between a primary block device and a secondary block device and wherein each of the primary block device and the secondary block device provides dedicated access to the end user, such that the primary block device and the secondary block device contain no other data other than the data of the end user and wherein the primary block device and the secondary block device are logically and physically controlled by the respective end user.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a system diagram of the Anti-Cloud System (ACS) of the present invention.

### DETAILED DESCRIPTION OF THE PREFERRED EMBODIMENTS

The invention is relevant to internet based storage that is in a known physical location. The known physical location is a specific block device, and its mirrored copy, located at a specific physical location and under the physical and logical control of the end user at that remote location. The invention may be useful, for example, in a number of regulatory environments in which data transport and storage requirements stipulate data retention specifics, known data destruction (when data is “destroyed” it is really destroyed and additional copies are not “hiding” somewhere), redundant electrical power supply, etc.

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

The Anti-Cloud System of the present invention ensures that the user's data is stored only in a location which the end user has both logical and physical control over. Data within the Anti-Cloud System is stored on a primary block device and on a secondary block device that is mirrored from the first for redundancy. These two specific block devices are under both the logical & physical control of the end user.

For example, if the end user requests their block devices, those specific drives will be shipped to them. Because of the specific design of the Anti-Cloud System, those block devices are immediately and directly usable in their home PC or existing IT infrastructure. The specific block devices which contain their data do not contain data for any other user of the Anti-Cloud System.

Because the user's data is not shared in any other storage medium, the user is then in possession of all copies. This ensures that there are no other hidden or lost copies of their data. From a data destruction compliance perspective, if the user has placed unique data on their Anti-Cloud drive(s), and both the primary and secondary drives are destroyed, it is known that all copies of the data stored therein are also thus destroyed. Likewise, for security sake, if the user places unique data on their Anti-Cloud drive(s), and later requests their disks and obtains them, it is known that no other copies of their unique data resides anywhere else but on those disks. These disks can be directly attached to their home PC or existing IT infrastructure, such as Windows, Linux, or other operating systems, and they can directly access their own data without any laborious conversion process as a traditional cloud storage system would require.

### Assembly of the Anti-Cloud System Components:

The Anti-Cloud System presents several software interfaces (such as Samba, Open Source Data Backup Software, etc.) which, in combination with the novel software and systems such as Open Source Virtual Private Network (VPN) Software, port tunneling, and/or pre-shared key client authentication (PSK) systems and procedures, provides the client with data storage, data access, data backup, data recovery, data deletion and data state at any point in time. Also, an exemplary embodiment of the invention ensures the physical location of data inside the system is discernable at the level of specific physical disk storage devices.

Thus, the Anti-Cloud System provides storage, encrypted transfer and physical control of data with point in time file history and is found in a format which is readily usable outside the Anti-Cloud System should the user request their disks.

The Anti-Cloud System provides snapshots of data at points in time through its backup software. It allows the user to access the data from a variety of platforms including, but not limited to, Microsoft Windows Operating Systems, GNU/Linux based Operating Systems, Google Android Operating Systems, Apple iOS Operating Systems and *BSD Operating Systems.

An exemplary embodiment of the present invention includes client-side and server-side software. The two sides negotiate a secure connection using AES-256 encryption (for example) to ensure data security and use HMAC authentication signatures per packet to ensure data integrity. Each connection from a client to the Data Assimilation Server (DAS) cluster uses its own unique keysets in order to keep client's data private. HMAC is a message authentication code involving a hash function and a secret cryptographic key.

At an Anti-Cloud System Data Center, connectivity is provided through high-speed routers which connect the Anti-Cloud System infrastructure to the internet.

The unique, secure connection from each client identifies the client to the DAS cluster. These servers handle the incoming data and provide access to the storage systems. Each client receives dedicated access to their own individual block device located in the storage systems.

At the DASs, the standard Windows SMB protocol, WebDAV protocol and a backup protocol are made available to each client. Each client has their own instances of SMB, WebDAV and the backup software service dedicated to their use. There is no sharing of protocols among users, each user's instance is dedicated only to their use.

The users at the client side are then able to pass SMB, WebDAV and backup traffic to and from the dedicated storage in the Anti-Cloud System infrastructure.

A database (“DB”) is also in communication with the DAS. DB includes data used to configure a connection between each client and their respective DAS. The DB lives on a dedicated database server. Each DAS communicates to the DB via standard networking protocols.

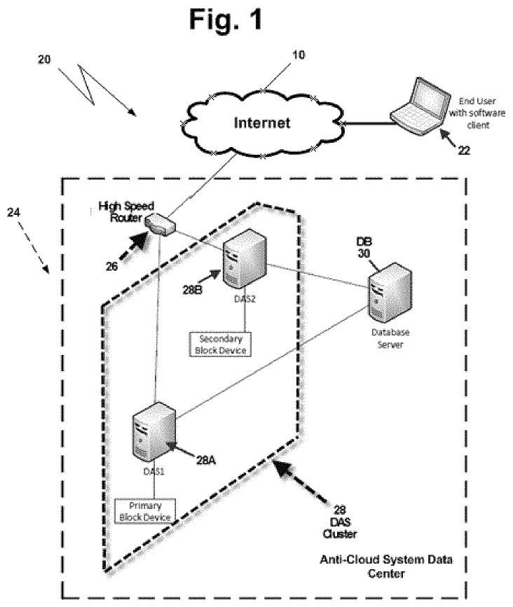

FIG. 1 provides a system diagram of the Anti-Cloud System (ACS) 20 of the present invention. In particular, the ACS 20 comprises an end user device 22 (computer, laptop, etc.; hereinafter the term “end user” implies the device 22) comprising software client, which in turn is connected to the internet 10. The ACS 20 further comprises the Anti-Cloud System Data Center 24 which comprises the DAS cluster 28 which is coupled to the internet 10 via the high speed router 26. The DAS cluster 28 is coupled to the database DB 30. The DAS cluster 28 comprises the primary and secondary block devices 28A and 28B.

### Access of Files:

### Samba (Exemplary Server Message Block/Common Internet File System (SMB/CIFS) Protocol):

The samba server software is running on the DAS. It makes storage available for files to be read, written, edited and deleted from any samba compatible client. This includes Microsoft Windows Client computers, Linux computers, *BSD computers and any other device configured to access the Samba network share. Use of the samba server software is further described in the example that appears below.

### Open Source Backup Software:

The Open Source Backup Software can be accessed with a web browser. It provides access to backup services such as point-in-time snapshots, individual file backups and other standard backup operations.

### Connection Between Endpoints:

In an exemplary embodiment of the present invention, connection between endpoints may be accomplished by using an Open Source VPN Software. This example is more clearly described below.

### Transfer of Files:

The backup system transfers files in its own internal format. These files are then stored on the user's disk in an area dedicated to just the backup system. General purpose transferring of files is accomplished through the Samba/SMB protocol or through Web Distributed Authoring and Versioning (WebDAV). The data is compressed to ensure faster transfer through settings in the VPN configuration.

### DAS Storage System:

The DAS connects to disk storage available on a back end storage system. The system ensures that disk storage is available and in the correct state prior to initiating transfers. It has software mechanisms to recover into the correct state should there be an issue on the block device.

In the event of either the primary or mirrored disk failing, notifications are sent to support staff who then replace the failing drive. The mirroring system of the Anti-Cloud System is used to duplicate the data back to the new drive so that both drives are synchronized with one another and the user's data remains intact.

### Endpoint Connections:

Endpoint connection may be accomplished, for example, through the use of Open Source VPN Software. In one exemplary embodiment of the present invention, each computer at the client's side is identified by a set of cryptographic keys that belongs to that client. So, all computers for a given account use the same cryptographic key, which identifies that account. The matching keyset at the DAS is bound to a specific IP port number and VPN instance. A database entry maps a user's specific disk to their account information, including that crypto key, and is mapped to their home directory.

So, by knowing the crypto key of the user, the DB links together their specific block device (by way of example only, a hard drive, etc.), the specific port number they have to connect to, their private IP space, and all metadata about the account. This DB is primarily used for provisioning of new users and support of existing users, but not during the actual connection.

The cryptographic keys are used in the setup of the initial connection for the Open Source VPN Software (for example). Once the VPN connection has been created, it is generally referred to as a “tunnel”, because the specific details of the cryptography involved are not important to the applications which use the virtual network it provides. The VPN runs in the background, transparently handling the encryption/decryption details. In establishing the VPN, keys are exchanged, and the “tunnel” becomes available.

The handshake in the VPN has completed, the matching/corresponding sets of port numbers, IPs and encryption keys has been exchanged and cached on either side and the VPN provides a new virtual network interface which, as far as applications are concerned, mimics everything that a real hardware network interface would provide. Any new information that is sent to that network interface is handled transparently by the Open Source VPN software. The initial configuration of the VPN is when it talks to the DB directly. After initial configuration, the DB is no longer touched by the VPN client. It's only during the customer sign-up and provisioning phase that the DB is ever used.

In one exemplary embodiment, the encryption keys are preferably used by the Open Source VPN Software to establish the tunnel. The process of provisioning a new user means creating a new set of keys, just for that user, and saving them to the DB so that they can be referred to later. Possible reasons for accessing the keys later include regenerating a config file for the user because they lost theirs, facilitating the creation of a different config using the same keys, with a slightly-adjusted configuration for this particular user, etc. By having them saved in the DB, it allows for the creation of different VPN templates for the same user, using the same keys, but with other options (i.e. compression, other network optimization parameters, etc.). For example, the template that is the starting point works perfectly for Windows machines. There could potentially be a situation where, for a future release, it is desired to be able to operate with Android or iOS (for example) and slightly different parameters might be necessary for optimal performance over cellular networks. In that case, the encryption keys remain the same because it's the same user account, but the specific VPN parameters will be tweaked to improve performance for cellular. Having them stored in the DB provides the ability to quickly and easily apply the same keys to a different template and distribute that template to the user for their specific device.

The procedure for allowing a user to select a letter drive (“Z” in the above example) and access a dedicated storage device may be accomplished through the use of what is commonly known as a “stack”. Each layer of the stack talks to only the layers immediately above and below it and uses predefined ways to do so. Samba does not participate in the specific mapping of a user to an address and port number, but it talks to layers which, below them, perform the mapping, transparently to Samba. Samba doesn't know or care how it happens, so long as it is able to talk to the next layer down. Subsequent layers in the stack perform the necessary translations from one layer to the next. So, at the bottom-most layer, there is the public internet address of the server, say 162.210.184.111. On port 10000 of that address is a server instance of the Open Source VPN Software.

When a client connects to that and exchanges encryption keys properly with that server instance, the client now basically “hides” that 162.210.184.111 port 10000 and exposes its own network address to the user, 10.1.5.1. The user does not need to interact directly, nor have any applications aware of the fact that data is actually going to 162.210.184.111:10000, it only cares about 10.1.5.1.

The Open Source VPN Software client layer in the stack is the only thing that cares about it. So, when a user starts up Windows Explorer and clicks on “map network drive”, they can enter into that box:

\\10.1.5.1\
and get access to the Samba service. In one exemplary embodiment, the installer automatically provides such mapping for a user as part of the initial installation of the software. When the user enters a username & password, the software authenticates and obtains the configs from the server and then performs the client configuration so that the user does not have to worry about how to map the drive letter themselves or to configure the backup software themselves. However, if a user wishes, they can use the samba services built-in to Windows to map a drive letter manually.

The following is a list of generalized layers which show the different layers that the data passes through from the client all the way to their specific disk. Each layer provides access to the layer below it, but does not necessarily know anything at all about layers beyond the layer it sits on. The reason for this is so that each different layer can be replaced, upgraded or changed without affecting other layers. Technology and details in a specific layer can be improved and changed and as long as it talks to its neighboring layers the same way as before, the end-to-end system continues to work.
Samba Client/Backup Client Software/WebDAV client (software on the client computer)
Open Source VPN Software client provides private address
   Public internet connectivity and network infrastructure
Open Source VPN Software server with public address
Samba server/Backup Server software/WebDAV server
OS disk device (hardware abstraction layer)
Local disk controller
Individual disk, directly attached to disk controller
   It should be noted that “database” does not appear in the above list. The reason is because the database is used only for provisioning a new customer and storing the keys they use. Before the client signs up and pays, there is no entry for the customer in the DB. When they sign up and pay, a process runs which finds a DAS with an available disk and gets its available port numbers and allocates that port number and disk to that person. The encryption keys the Open Source VPN Software uses are created and stored in the DB and from that a template is used to create a specific Open Source VPN, Samba, Backup server and WebDAV config for that user. The configs are created and the services started & bound to that address and the disk is mounted to a directory that is just for their use. Once config files are created from the templates and info in the DB, they do not need to be re-created again unless there is some maintenance issue that requires it.

The Anti-Cloud System does not get in the way of normal application operation. It provides a standard drive letter to the Windows operating system, just like any other network operating system does. Applications can save their data anywhere available to the user, at the direction of the user. The disk is accessed via standard file-sharing systems such as SMB and the backup system and private address space inside the VPN (i.e. bound to that cryptographic key) is where their specific instance of the WebDAV, SMB and backup software runs. Each client gets their own, dedicated instance of those services, bound only to the private address space inside their VPN. A user that does not have the correct crypto keys cannot access any aspects of any other user.

If a user saves data to the drive letter that the Anti-Cloud System provides to them, it is readily available to them whenever they are connected to the Anti-Cloud System. Whether their application is local or cloud based is immaterial, because, if the application is capable of saving data to a drive letter, the Anti-Cloud System is one of the drive letters provided to the user as a place to store it.

The SMB protocol and WebDAV protocols are specifically used for mapping drive letters in this kind of environment.

For example, a user with a standard Windows setup will have a C: drive of their own where the host operating system lives and where they will typically store files. When they connect to the Anti-Cloud System, they will then have a Z: drive (for example) available to them. They can use the typical Windows file managers to move files to/from the Z: drive just like any other drive.

Thus, a user sees their dedicated block device as a lettered drive (“Z” as an example) when viewing their directory. A user simply saves (or otherwise accesses) to that lettered drive just as they would save to any other drive to which they have access. This is further explained below.

The Anti-Cloud System uses all the standard features of the SMB protocol, which means that one user can access multiple SMB shares located on the same physical device, and likewise many individuals with the correct permissions (configurable within the Anti-Cloud software interface) can access a single SMB share.

For example, Windows via its standard protocol Samba/SMB provides network access to drives. Other platforms use WebDAV for file access over the network.

A save to that drive results in the save instruction being directed to the Data Assimilation Server cluster. This occurs over the secure connection that is established, for example, using an Open Source VPN Software. Therefore, the Open Source VPN Software itself (or an equivalent piece of software) handles all the IP addressing in order to direct the save to your DAS cluster. This is further described below.

Ultimately, the save is directed to a specific disk using a database that maps the save to that specific disk.

During a “save” operation from the client side, however, the DB is long since out of the picture. It's prior to this that the DB provides the mapping. Here is a step-by-step numbered explanation:
1. Each DAS has at least 1 IP address and up to 64 k port numbers that it owns. Each port number can be a potential customer. Each DAS can handle a large number of individual users.
2. Periodically, each server in the DAS cluster catalogs the disks that are available to it and their availability status (i.e. “in use by a customer” or “available to be given to a customer”) and enters the disk into the DB. The DB contains the identity of the machine that holds the disk and the identity (brand, model, capacity, serial number, slot number, etc.) of the disk itself. The disks it talks to are provided over either directly-connected or by a NAS device, so it has a large number of individual disks that it can handle.
3. User signs up at the web site (for example), selects a disk size, gives payment details and a username & password that they wish to use. The username & password are tested by the Anti-Cloud System for uniqueness and strength so that the user doesn't duplicate someone else's account name and doesn't provide a weak password. Once payment has been captured, their account is marked as having paid, but not yet provisioned.
4. The user's order specifies a particular bandwidth which they are allocated within the Anti-Cloud System network. Rules are implemented in the Anti-Cloud System infrastructure which reserve that bandwidth for the specific user and prioritize traffic within the network such that the user has been “guaranteed” that bandwidth availability, if their connectivity to the internet and to the Anti-Cloud System infrastructure permits it.
5. Upon payment event, software on the DB server runs and queries the DB looking for entries in the DB that are marked as “paid, but not provisioned” and correlates that in the DB to a drive of matching capacity that is available to provision.
6. The software on the DB side allocates that disk by updating its status to “in use by a customer” and selects the identity of the individual DAS server which owns that drive and an available port number on that DAS (port numbers are not physical ports, but a number in a network packet that identify a unique connection). This combination of the DAS's IP address and the port number then belongs to that specific user.
7. This is a direct, 1:1 map of (user account)=(IP & port). Part of this allocation process is creation and/or allocation of the encryption keys. When the software finishes provisioning all the services for this user, the DB now has a map of (user account)=(IP & port)=(specific encryption key)=(specific instance of Open Source VPN Software that is bound to their DAS' IP & port only)=(specific, private address space for this account)=(specific instances of services running on the DAS and bound to the private vpn address space).
8. This is the last time the DB will do anything for this particular user until the user cancels their account. The Open Source VPN Software provides this private VPN address space just as if that server was located inside the same physical network as the client's machine. For example, this instance of the Open Source VPN Software running on the server will be at 10.1.5.1 and the client's computer will be at 10.1.5.2.
9. The Open Source VPN Software is configured to allow a user many client machines within this account, 10.1.5.2-10.1.5.254. Once these initial configuration files are created, with their own specific IP, port and other user-specific settings, there is no more interaction between these services and the DB.
10. When done with provisioning the drives for the user, the software on the DB side emails back to the user an email basically saying “your account is now ready” and a link to the client software with instructions for downloading & installation and completing any contractual obligations, such as digital signature to enable the service.
11. User clicks the link, downloads and installs the client software and is prompted for the username & password which they created at signup. Client software includes the Open Source VPN Software executable. When they enter the username/password correctly, client software queries the DB side for the configuration file and copies the config permanently to the user's computer.
12. As soon as it's copied to the computer, the Open Source VPN Software is executed with that config and a “first run” program configures up the local backup program and designates the drive letter, i.e. “Z:”, to map to the VPN address of the remote server.
13. Once the initial setup is completed, the user is able to use the Anti-Cloud System Services. When they restart, the client software automatically restarts with the computer after a reboot. The Open Source VPN Software config file only talks to that very specific IP & port on that specific DAS, so every time it restarts, it connects back only to the specific DAS that it was setup for. If a malicious actor were to attempt to change the IP or port to try to reach a different user's account, they would be immediately stopped, because their encryption keys are fundamentally different from the encryption keys of the user they are attempting to connect as, and the VPN would not be capable of negotiating a connection at all. So, because the VPN tunnel never comes up, none of the private Anti-Cloud System Services behind it are ever exposed.
14. When a user terminates their Anti-Cloud System Service, the IP address and port are marked as inactive in the DB and the account is disabled by the DB server. It signals the DAS to turn off the instance of the Open Source VPN Software that is bound to that specific IP address and port, thereby destroying the encryption keys that were used by it. Because their encryption keys are gone, that user can never login again even with their old encryption keys. The disk they had is removed from the storage system and shipped to the end user. Their IP address and port number is now “free” and can be re-used by a new user, with all-new encryption keys, with no commonality whatsoever to the previous user.

Software for performing the above steps may be stored in a non-transitory machine-readable storage medium. The term “machine-readable storage medium” should be taken to include a single medium or multiple media (e.g., a centralized or distributed database and/or associated caches and servers) that store the one or more sets of instructions.

The term “machine-readable storage medium” shall also be taken to include any medium that is capable of storing or encoding a set of instruction for execution by the machine and that causes the machine to perform any one or more of the methodologies of the disclosure. The term “machine-readable storage medium” shall accordingly be taken to include, but not be limited to, solid-state memories and optical and magnetic media.

Some portions of the detailed descriptions are presented in terms of algorithms and symbolic representations of operations on data bits within a computer memory.

These algorithmic descriptions and representations are the means used by those skilled in the computer arts to most effectively convey the substance of their work to others skilled in the art. An algorithm is here and generally conceived to be a self-consistent sequence of steps leading to a desired result. The steps are those requiring physical manipulations of physical quantities.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “receiving”, “determining”, “associating”, “updating”, “providing”, “integrating”, “selecting”, “executing”, “processing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples described herein also relate to an apparatus for performing the methods described herein. This apparatus may be specially constructed for performing the methods described herein or it may comprise a general-purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein or it may prove convenient to construct more specialized apparatus to perform the above methods and/or each of its individual functions, routines, subroutines or operations. Examples of the structure for a variety of these systems are set forth in the description above.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A system for providing an end user with dedicated storage over a secure internet connection in a remote location, said system comprising:
a data assimilation server cluster which uses unique keysets for maintaining data of the end user private, the data assimilation server being in communication with the end user over the secure internet connection via a router;
a database in communication with the data assimilation server cluster for storing data used to configure a connection between the end user and the data assimilation server cluster;
a primary block device; and
a secondary block device,
wherein the connection between the end user and the data assimilation server cluster comprises a connection between the end user and the primary block device and the secondary block device and wherein each of the primary block device and the secondary block device provides dedicated access to the end user such that the primary block device and the secondary block device contain no other data other than the data of the end user and the primary block device and the secondary block device are logically and physically controlled by the end user.

2. The system of claim 1 wherein the communication between the end user and the data assimilation server cluster is a secure communication.

3. The system of claim 1 wherein the database is only used for provisioning a new end user and for storing encryption keys to establish a respective account for each end user.

4. The system of claim 3 wherein the end user comprises encryption keys and wherein the data assimilation server cluster comprises a matching keyset which is bound to a specific internet protocol (IP) port number and virtual private network instance.

5. The system of claim 4 wherein the database maps a storage drive of the end user to particular account information which is also mapped to a home directory wherein the database links the primary and secondary block devices with specific port numbers.

6. The system of claim 5 wherein the system establishes a virtual private network (VPN) between the end user and the data assimilation server cluster.

7. The system of claim 6 wherein the VPN comprises a stack having a plurality of layers and wherein any one layer therein communicates only with immediately adjacent layers.

8. The system of claim 7 wherein the end user is provided with a primary storage device on the primary block device and a secondary storage device on the secondary block device to which the end user can store files and from which the end user can retrieve files using a conventional file manager of a Windows or Linux operating system without a data conversion process.

9. A method for providing an end user with dedicated storage over a secure internet connection in a remote location, said method comprising:
providing a data assimilation server cluster that is in communication over the secure internet connection using a router, the data assimilation server cluster comprising unique keysets for maintaining data of the end user private;
connecting a database in communication with the data assimilation server cluster, the database storing data used to configure a connection between the end user and the data assimilation server cluster; and
wherein the connection between the end user and the data assimilation server cluster comprises forming a connection between a primary block device and a secondary block device and wherein each of the primary block device and the secondary block device provides dedicated access to the end user, such that the primary block device and the secondary block device contain no other data other than the data of the end user and wherein the primary block device and the secondary block device are logically and physically controlled by the respective end user.

10. The method of claim 9 wherein the step of providing communication between the end user and the data assimilation server cluster is a secure communication.

11. The method of claim 9 wherein the step of connecting the database is only used for provisioning a new end user and for storing encryption keys to establish a respective account for each end user.

12. The method of claim 11 wherein the step of providing communication between the end user and the data assimilation server cluster comprises providing encryption keys to the end user and providing the data assimilation server cluster with a matching keyset which is bound to a specific internet protocol (IP) port number and virtual private network instance.

13. The method of claim 12 wherein the step of connecting the database comprises database mapping a storage device of the end user to particular account information which is also mapped to a home directory wherein the database links the primary block device and the secondary block device with specific port numbers.

14. The method of claim 13 wherein the steps of providing communication between the end user and the data assimilation server cluster and of connecting the database establishes a virtual private network (VPN) between the end user and the data assimilation server cluster.

15. The method of claim 14 wherein the step of establishing the VPN comprises forming a stack having a plurality of layers and wherein any one layer therein communicates only with immediately adjacent layers.

16. The method of claim 15 wherein the step of establishing the VPN comprises providing the end user with a primary storage device on the primary block device and a secondary storage device on the secondary block device to which the end user can store files and from which the end user can retrieve files using a conventional file manager of a Windows or Linux operating system without a data conversion process.
